(19) United States
(12) Patent Application Publication
(10) Pub. No.: US 2013/0076186 A1
(43) Pub. Date: Mar. 28, 2013

(54) SPINDLE MOTOR

(71) Applicants: Nam Ki Park, Gyunggi-do (KR); Sang Jin Park, Gyunggi-do (KR)

(72) Inventors: Nam Ki Park, Gyunggi-do (KR); Sang Jin Park, Gyunggi-do (KR)

(73) Assignee: SAMSUNG ELECTRO-MECHANICS CO., LTD., Gyunggi-do (KR)

(21) Appl. No.: 13/303,442

(22) Filed: Nov. 23, 2011

(30) Foreign Application Priority Data
Sep. 22, 2011 (KR) 1020110095695

(51) Int. Cl. H02K 21/22

(52) U.S. Cl. 310/156.04

(57) ABSTRACT

Disclosed herein is a spindle motor including: a rotor including a shaft, a hub, and a magnet; a stator including a sleeve rotatably supporting the shaft, a base having the sleeve coupled thereto, and an armature facing the magnet, fixedly coupled to the base, and including a core and a coil; and a fluid dynamic bearing part formed between the rotor and the stator by being filled with oil, wherein the stator further includes a pulling plate disposed to face the magnet in an axial direction of a shaft, coupled to the base, and protruded upwardly toward the core in a axial direction of a shaft.

### CROSS REFERENCE TO RELATED APPLICATION

This application claims the benefit of Korean Patent Application No. 10-2011-0095695, filed on Sep. 22, 2011, entitled “Spindle Motor”, which is hereby incorporated by reference in its entirety into this application.

### BACKGROUND OF THE INVENTION

1. Technical Field

The present invention relates to a spindle motor.

2. Description of the Related Art

Generally, in a spindle motor used as a driving device of a recording disk such as a hard disk, or the like, a fluid dynamic bearing using dynamic pressure generated by a lubricating fluid such as oil, or the like, stored between a rotor and a stator at the time of rotation of the motor has been widely used.

More specifically, since the spindle motor including the fluid dynamic bearing that maintains shaft rigidity of a shaft only by movable pressure of lubricating oil by centrifugal force is based on centrifugal force, metal friction does not occur and a sense of stability increases as a rotation speed increases, such that the generation of noise and vibration is reduced and a rotating object can be more readily rotated at a high speed than a motor having a ball bearing. As a result, the spindle motor has been mainly applied to a high end optical disk device, a magnetic disk device, or the like.

However, the spindle motor according to the prior art having the fluid dynamic bearing has a problem that vibration is generated by torque ripple. In order to solve this problem, an attempt to alleviate torque ripple in an axial direction of a shaft by including a pulling plate has been conducted. However, there is still a problem that torque ripple in an axial direction of a shaft generated due to a difference in relative position between a core and a magnet may not be removed.

### SUMMARY OF THE INVENTION

The present invention has been made in an effort to provide a spindle motor in which a pulling plate protruded upwardly toward a core of the spindle motor in a axial direction of a shaft is included to reduce a cogging torque, such that vibration in an axial direction of a shaft may be reduced, a protrusion part protruded upwardly is formed to have a circular shape having a radius of curvature, such that reduction of the cogging torque may be maximized, and an insertion coupling part protruded downwardly toward a base is insertedly coupled to the base, such that a standing property may be improved and the spindle motor may be stably driven.

According to a preferred embodiment of the present invention, there is provided a spindle motor including: a rotor including a shaft, a hub, and a magnet; a stator including a sleeve rotatably supporting the shaft, a base having the sleeve coupled thereto, and an armature facing the magnet, fixedly coupled to the base, and including a core and a coil; and a fluid dynamic bearing part formed between the rotor and the stator by being filled with oil, wherein the stator further includes a pulling plate disposed to face the magnet in an axial direction of a shaft, coupled to the base, and protruded upwardly toward the core in a axial direction of a shaft.

The pulling plate may include: a protrusion part protruded upwardly toward the core; and a plate part extended in a direction perpendicular to the protrusion part and coupled to the base.

The pulling plate may further include an insertion coupling part protruded downwardly from the plate part, and the base may be provided with a pulling plate insertion groove corresponding to the insertion coupling part, wherein the insertion coupling part of the pulling plate is insertedly coupled to the pulling plate insertion groove, such that the pulling plate is coupled to the base.

A bonding material may be applied to the pulling plate insertion groove of the base and the insertion coupling part of the pulling plate may be insertedly coupled thereto, such that the pulling plate is coupled to the base.

A plurality of slots may be formed in the core, and a plurality of protrusion parts of the pulling plate may be formed to face the plurality of slots.

### BRIEF DESCRIPTION OF THE DRAWINGS

FIG. 1 is a cross-sectional view schematically showing a spindle motor according to a preferred embodiment of the present invention;

FIG. 2 is a cross-sectional view schematically showing an armature and a pulling plate shown in FIG. 1; and

FIG. 3 is a schematic front view of the pulling plate shown in FIG. 2 in a radial direction of a shaft.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, a spindle motor according to preferred embodiments of the present invention will be described in detail with reference to the accompanying drawings.

FIG. 1 is a cross-sectional view schematically showing a spindle motor according to a preferred embodiment of the present invention. As shown, the spindle motor 100 is configured to include a rotor including a shaft 110, a hub 120, a magnet 130, and a thrust plate 140; a stator including a sleeve 150, a base 160, an armature 170, a sealing member 180, a pulling plate 190, and a cover 152; and a fluid dynamic bearing part formed between the rotor and the stator by being filled with oil, which is working fluid.

In the rotor, the shaft 110 includes the hub 120 coupled to an upper end thereof and the thrust plate 140 coupled to a gap between the shaft 110 and the sleeve 150, wherein the thrust plate forms a thrust dynamic bearing part.

In addition, the hub 120 includes a cylindrical part 121 fixed to the upper end of the shaft 110, a disk part 122 extended from the cylindrical part 121 in an outer diameter direction, and a sidewall part 123 extended downwardly from an end of the disk part 122 in the outer diameter direction in an axial direction of the shaft.

In addition, the sidewall part 123 includes an annular ring shaped magnet 130 mounted on an inner peripheral surface thereof so as to face the armature 170 including the core 171 and the coil 172.

Next, in the stator, the sleeve 150 rotatably supports the shaft 110 and is fixed to the base 160.

In addition, the sleeve 150 according to the spindle motor 100 according to the preferred embodiment of the present invention includes an oil circulation hole 151 formed therein in an axial direction of the shaft 110 so as to connect upper and lower surfaces thereof to each other in order to circulate oil through a shaft system.

In addition, the sealing member 180 is coupled to the sleeve and is disposed on an upper portion of the thrust plate 140 coupled to the shaft to thereby form an oil interface.

Further, the cover 152, which is to seal the oil injected in order to form the fluid dynamic bearing, is fixed to an inner peripheral surface of a lower end of the sleeve 150.

In addition, a radial dynamic bearing part (not shown), which is the fluid dynamic bearing part, is formed between the sleeve 160 and the shaft 110. More specifically, the radial dynamic bearing part is formed by forming a micro-gap between the shaft 110 and the sleeve 150 and filling the oil in the micro-gap.

To this end, the radial dynamic bearing part is formed by selectively forming a dynamic pressure generation groove (not show) in an inner peripheral surface of the sleeve 150 or an outer peripheral surface of the shaft 110 facing the inner peripheral surface of the sleeve 150. In addition, the dynamic pressure generation groove may be selectively formed in pair at upper and lower portions of the inner peripheral surface of the sleeve or upper and lower portions of the outer peripheral surface of the shaft.

Further, the base 160 includes the armature 171 fixed to an outer peripheral portion thereof by press-fitting, adhesion, or the like, so as to face the magnet 130 and includes the sleeve 150 fixed to an inner peripheral portion thereof by press-fitting, adhesion, or the like, wherein the armature 170 includes the core 171 and the coil 172.

Next, the pulling plate 190 is disposed to face the magnet 130 in the axial direction of a shaft and is fixed to the base 160, in order to prevent floating of the hub 120. More specifically, the pulling plate 190 includes a protrusion part 191, a plate part 192, and an insertion coupling part 193.

The protrusion part 191 is protruded upwardly toward the core 171 in the axial direction of a shaft, the plate part 192 is extended in a direction perpendicular to the protrusion part 191 and coupled to the base 160, and the insertion coupling part 193 is protruded downwardly from the plate part 192 and is insertedly coupled to the base. To this end, the base 160 includes a pulling plate insertion groove 161 formed therein, wherein the pulling plate insertion groove 161 corresponds to the protrusion part 191 of the pulling plate 190.

In addition, a bonding material is applied to the pulling plate insertion groove 161 and the insertion coupling part 193 of the pulling plate is insertedly coupled thereto, such that the pulling plate is firmly coupled to the base 160 while maintaining a standing property.

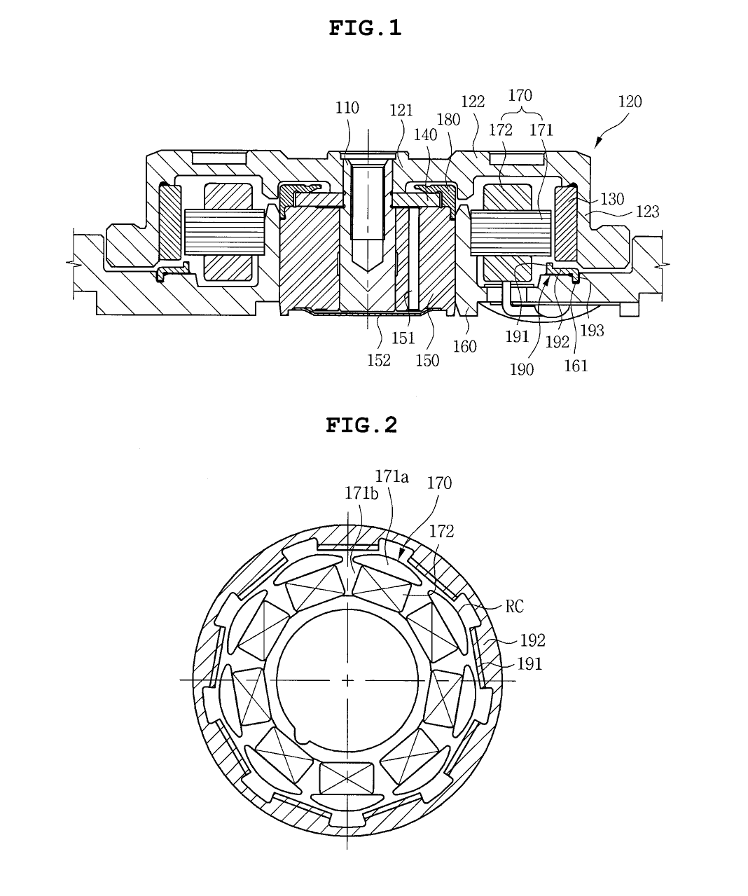

FIG. 2 is a cross-sectional view schematically showing an armature and a pulling plate shown in FIG. 1. As shown, an end of the core 171 is formed to have a circular shape 171a having a radius of curvature and includes a plurality of slots 171b formed in a radial direction. In addition, the protrusion parts 191 of the pulling plate 190 are formed to face the slots 171b of the core 171. Further, the number of protrusion parts 191 of the pulling plate is the same as that of slots 171b formed in the core.

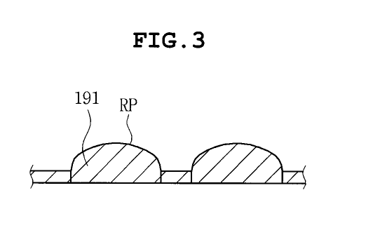

FIG. 3 is a schematic front view of the pulling plate shown in FIG. 2 in a radial direction of a shaft. As shown, the protrusion part 191 is formed to have a circular shape having a radius of curvature. More preferably, a radius of curvature of the protrusion part 191 with respect to a curved part (RP) is 0.5 times or more to 3 times or less than that of the core with respect to a curved part RC. This takes into consideration the effects of reducing a cogging torque and vibration according to a radius of curvature.

The spindle motor 100 according to the preferred embodiment of the present invention includes the pulling plate 190 including the protrusion part 191, the plate part 192, and the insertion coupling part 193, thereby making it possible to reduce the cogging torque and reduce the vibration of the pulling plate in a radial direction as well as in an axial direction of a shaft, by the protrusion part 191.

According to the preferred embodiment of the present invention, it is possible to obtain a spindle motor in which a pulling plate protruded upwardly toward a core of the spindle motor in a axial direction of a shaft is included to reduce a cogging torque, such that vibration in an axial direction of a shaft may be reduced, a protrusion part protruded upwardly is formed to have a circular shape having a radius of curvature, such that reduction of the cogging torque may be maximized, and an insertion coupling part protruded downwardly toward a base is insertedly coupled to the base, such that a standing property may be improved and the spindle motor may be stably driven.

Although the preferred embodiments of the present invention have been disclosed for illustrative purposes, they are for specifically explaining the present invention and thus a spindle motor according to the present invention is not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A spindle motor comprising:
a rotor including a shaft, a hub, and a magnet;
a stator including a sleeve rotatably supporting the shaft, a base having the sleeve coupled thereto, and an armature facing the magnet, fixedly coupled to the base, and including a core and a coil; and
a fluid dynamic bearing part formed between the rotor and the stator by being filled with oil,
wherein the stator further includes a pulling plate disposed to face the magnet in an axial direction of a shaft, coupled to the base, and protruded upwardly toward the core in a axial direction of a shaft.

2. The spindle motor as set forth in claim 1, wherein the pulling plate includes:
a protrusion part protruded upwardly toward the core; and
a plate part extended in a direction perpendicular to the protrusion part and coupled to the base.

3. The spindle motor as set forth in claim 2, wherein the pulling plate further includes an insertion coupling part protruded downwardly from the plate part, and
wherein the base is provided with a pulling plate insertion groove corresponding to the insertion coupling part, and the insertion coupling part of the pulling plate is insertedly coupled to the pulling plate insertion groove, such that the pulling plate is coupled to the base.

4. The spindle motor as set forth in claim 3, wherein a bonding material is applied to the pulling plate insertion groove of the base and the insertion coupling part of the pulling plate is insertedly coupled thereto, such that the pulling plate is coupled to the base.

5. The spindle motor as set forth in claim 2, wherein a plurality of slots are formed in the core, and a plurality of protrusion parts of the pulling plate are formed to face the plurality of slots.
